(19) United States
(12) Patent Application Publication
(10) Pub. No.: US 2014/0337147 A1
(43) Pub. Date: Nov. 13, 2014

(54) Presentation of Engagment Based Video Advertisement

(71) Applicant: Exponential Interative, Inc., Emeryville, CA (US)

(72) Inventors: Dilip DaSilva, Albany, CA (US); Niket Arora, Faridabad (IN); Madhukar Sharma, New Delhi (IN)

(73) Assignee: Exponential Interactive, Inc, Emeryville, CA (US)

(21) Appl. No.: 13/892,452

(22) Filed: May 13, 2013

(51) Int. Cl. G06Q 30/02

(52) U.S. Cl. CPC G06Q 30/0241; G06Q 30/0277
USPC 705/14.73; 705/14.4

(57) ABSTRACT

A video advertisement is presented to a user in a teaser video window overlaying a content page. When the user interacts with the video advertisement in the teaser video window, the teaser video window is expanded to a full-size video window over a predetermined amount of time. The video expansion is substantially smooth and the video continues to play in the window during the expansion. The full-size video window may be accompanied by a mini-site overlaying the content page, and providing additional information to the user. If the user interacts with the content page, the full size video window is reduced in size to the teaser video window and the user may interact with the content page.

### BACKGROUND

This invention relates generally to advertising systems and more particularly to video advertisements provided to content viewers.

Advertising systems provide advertisements to users of publishing systems in a networked environment. The publishing system refers users to the advertising system to receive an advertisement when the user views content at the publishing system. Among the types of advertisements used by an advertising system are video advertisements. While video advertisements can be more interesting than static images, video effectiveness is diminished when viewers are not engaged in viewing the advertisement. Moreover, videos that are sufficiently disengaging may irritate users. Many video advertisements are initially presented in a teaser size, and then presented in a full-size video. However, users often disengage with the video advertisement when the full-size video is presented to the user.

### SUMMARY

An advertising selection system provides video advertisements to client devices. The video advertisement is presented to the user in a teaser video in the context of a web page. When the user interacts with the teaser video, the video expands to a full-size video, overlaying the web page. The video expansion is substantially smooth and continuous, such that the video expands from the size of the teaser video and ends at the size of the full-size video. In one embodiment, the user may interact with the web page while the video is expanding, and the interaction with the web page causes the expansion of the video to stop and then contract the video back to the teaser video size.

In one embodiment, the audio for the video is mute or silent so long as the video is played in the teaser video. In this embodiment, the audio is played when the full-size video is played. The audio may be silent while the video expands, the audio may play at normal volume, or the audio may increase in volume during the expansion and reach full volume when the video is fully expanded to the full-size. In one embodiment, the video re-starts when the video reaches full-size.

The video in one embodiment is played in a mini-site when the video is expanded to the full size. The mini-site is displayed in a window overlaying the web page. The full-size video is played in a mini-site that includes additional content related to the advertiser included in interactive panels of the window. The interactive panels allow the mini-site to play additional videos, and provide information related to the advertiser. When the mini-site is provided to the user with the full-size video display, additional portions of the web page are overlaid by the mini-site. However, the client device continues to display the original page content. When the user interacts with the original web page, the mini-site and full-size video are removed and the user can interact with the original content, and the video is reduced to the teaser video size. In this way, the video advertisement is responsive to user interest in the video and provides a smooth transition from the teaser video embedded in page content to a full-size video. The smooth transition from the teaser video to the full-size video increases user engagement relative to teaser videos that transition immediately into a full-size video without transition.

### BRIEF DESCRIPTION OF THE DRAWINGS

FIG. 1 is an overview of an environment with an advertising selection system according to one embodiment.

FIG. 2 is an interaction diagram for providing an advertisement according to one embodiment.

FIGS. 3A-C are example user interfaces for a video advertisement according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

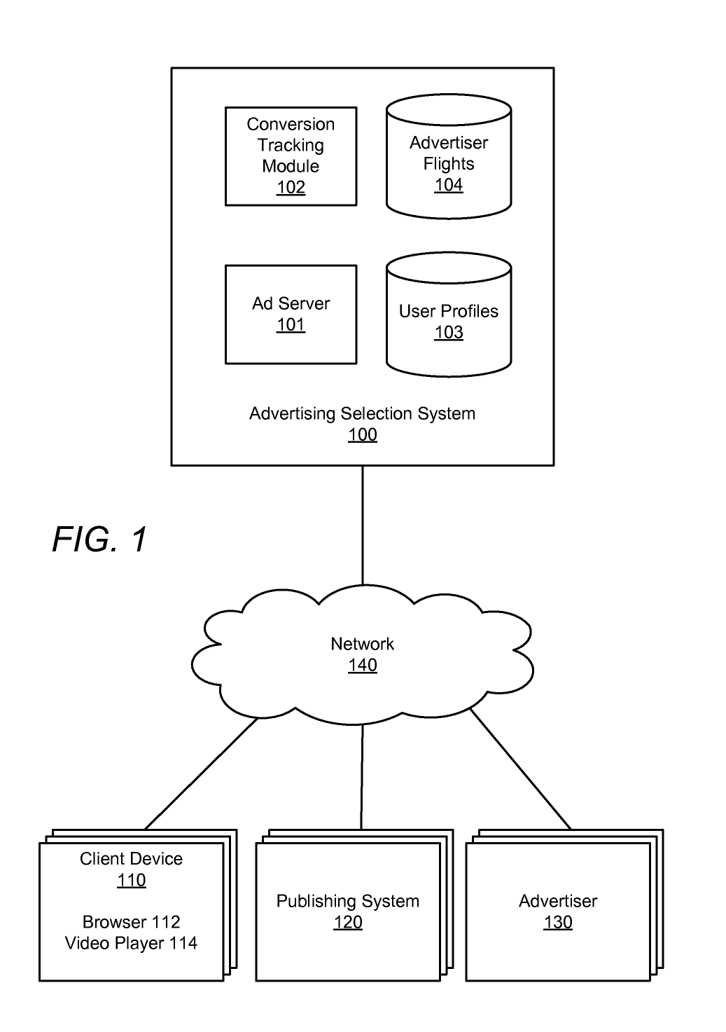

FIG. 1 is a block diagram of an advertising selection system 100 for determining attribution for conversion events performed by to a client device 110 according to one embodiment. A user of a client device 110 accesses a publishing system 120 to obtain a web page containing content, such as text, video, images, audio, applications, and so forth. The publishing system 120, when providing content to the client device 110 will also provide advertisements (“ads”) along with the web page. The advertisements are selected by the advertising selection system 100. To select an advertisement, the publishing system 120 includes a reference or universal resource locator (URL) with the web page it provides to the client device, typically to a browser 112 or other web enabled application. Typically, the reference is located in an advertising portion of a page, such as a side bar or a banner.

The client device 110 resolves this reference which generates a request for an advertisement provided to the advertising selection system 100. The advertising selection system 100 identifies an ad to provide to the user and serves the ad to the client device 110. Note that in FIG. 1, for the sake of clarity only one instance of publishing system 120, client device 110, and advertising data service 130 is shown, though in practice there will be any number of each.

When the client device receives the advertisement or at another time, the user of the client device 110 may use the ad to access the advertiser system 130, for example by clicking on a link in the ad. At that time, the user of the client device 110 may indicate an interest to the advertiser's message or product through some specific behavior, for example by purchasing an item using the advertiser system, completing a survey, requesting information, downloading information, applications, or other content from the advertiser system, interacting with the advertiser system in some other predetermined manner. This behavior is termed a “conversion” or a “conversion event.” The conversion event at the advertiser 130 provides a benefit to the advertiser 130 and is typically the goal of advertising. These conversion events are generally defined by the advertiser when the advertiser purchases advertising services with the advertising selection system selection 100.

Video advertisements may be provided to the user by the advertising selection system 100 while the user is accessing a web page on the publishing system 120. These video advertisements are presented to the user of the client device 110 in the window of a video player, in an advertising portion of the display. The video as displayed in the window of the video player 112 of the client device 110, and is referred to herein as a teaser video. The user may interact with the teaser video. The interaction of the user with the teaser video is termed an interaction event. The interaction event may be a user selecting the teaser video, clicking on the teaser video, hovering the cursor over the teaser video, increasing the volume of the teaser video, or otherwise showing taking an action that indicates an interest in the teaser video. As described further below, after an interaction event, the teaser video smoothly and continuously expands from the teaser video to a full-size video. The smooth and continuous expansion from teaser video to full-size video maintains user interest in the video and increases user engagement. In contrast, an abrupt transition from teaser video to full-size video may surprise and irritate users and reduce user engagement.

The advertising selection system 100 includes an ad server 101, a conversion tracking module 102, and various databases supporting these modules and functions. These databases include user profiles 103, and advertiser flights 104. Conventional features, such as firewalls, load balancers, authentication servers, application servers, failover servers, site management tools, and so forth are not shown so as to more clearly illustrate the features of the advertising selection system 100. In general, functions described in one embodiment as being performed by one component can also be performed by other components in other embodiments, or by a combination of components.

The advertising selection system 100 selects and provides advertisements to client device 110. In practice there are multiple different advertisers 130, and the particular advertiser 130 accessed by the client device 110 is determined based on the ad provided by the advertising selection system 100 and user actions on the client device 110. In addition, rather than the advertisement being provided by the advertising selection system 100, an advertiser 130 may provide the advertisement directly to the client device 110. For example, the advertising selection system 100 provides the user a reference to the advertiser 130 rather than directly providing the advertisement to the client device 110.

Client devices 110 are computing devices that execute client software, e.g., a web browser 112 or built-in client application, to browse the internet and connect with publishing system 120 and advertising selection system 100 via a network 140 to access content and accompanying advertisements. The client device 110 also executes a video player 114, either as an application or browser plugin, such as Adobe Flash, Microsoft Silverlight, Apple Quicktime, or the like. The client device 110 might be, for example, a personal computer, a personal digital assistant, a cellular, mobile, or smart phone, a laptop computer, a set-top receiver, or any similar device capable of accessing content and advertisements over the a network 140. Client devices request content from the publishing system 120. The client devices 110 typically request information using hypertext transfer protocol (HTTP), though other access protocols can be used. The received content can include web pages based upon HTML, CSS, or Javascript, or other mark-up or scripting languages, and can also include video, audio, or other content types. Though typically described herein relating to a browser using such mark-up languages, other technologies or applications may be used for displaying video advertisements as described herein.

The client device 110 retains a persistent identifier for its communication with the advertising selection system 100. A persistent identifier can be any persistent information to identify the client device 110 to the advertising selection system 100. The persistent identifier is typically a browser cookie or other piece of data maintained by the client device 110, though other information can also be maintained. The client device 110 may use unique browser cookies for each browser used on the device or for different users logged into the system. In addition, persistent identifiers are typically not unique to individual persons, but rather machine, browser, and user-specific. For example, a user browsing on a home computer will have a persistent identifier on the home computer which is distinct from a persistent identifier from a work computer. The same user will also have separate persistent identifiers associated with each type of browser they are using on a single device. Two users on the same computer that log in with separate identities will also have separate persistent identifiers. In addition, users may delete persistent identifiers from the client device 110. This causes a new persistent identifier to be generated for the device despite that there has been no change in device or user. As such, each persistent identifier may only identify particular devices and particular sessions. Other persistent identifiers are used in different implementations. For convenience, a reference herein to a “user” from the perspective of the advertising selection system 100 should be understood to refer to the persistent identifier unless clearly indicated that the “user” actually means the particular individual operating a client device, rather than the persistent identifier representing a cookie or other session-related identifier of the client device which is not relied on to identify specific users.

The persistent identifier in one embodiment also embeds associated behavioral information in the persistent identifier. The behavior information includes data about a set of behaviors associated with the persistent identifier. One type of behavior includes a topic from a behavioral vocabulary comprising a set of predetermine topics, and a behavioral attribute of the persistent identifier related to the topic. The topic vocabulary can be automatically generated from common words or phrases, based on existing topic sets such as WordNet or similar ontologies. The behavioral attributes can indicate information such as whether a user is searching for the topic, reading information about the topic, in the market for the topic (e.g., interested in purchasing a product or service related to the topic), and other behaviors related to the topic. The identified behaviors can be encapsulated in a browser cookie provided to the user and updated to indicate behaviors identified by the advertising selection system 100, for example as tuples of topic IDS and behavior IDs. In alternate embodiments, the browser cookie is only an identifier of the user and does not include any further information about the user's behavior. In these embodiments, the persistent identifier is used by the advertising selection system 100 to locate the user profile located on the advertising selection system 100. The user profile contains all the data pertaining to the persistent identifier, including behavioral data.

The publishing system 120 can be any content source accessible by the client device 110 that provides advertisement selections from advertising selection system 100. For example, the publishing system 120 may provide content pages using the technologies described above. The content can include news, video, informational pages, and various other types of information to the client device 110. Examples of content sources include social networks (e.g., FACEBOOK™), e-commerce sites (e.g., AMAZON™), news sites (e.g., CNN.com), blogs, user forums, video hosting services (e.g., YOUTUBE™, HULU™), audio hosting services (e.g., PANDORA™, SLACKER™) and so forth.

The network 140 provides a communications medium to enable correspondence between the advertising selection system 100, the client device 110, the publishing system 120, and the advertiser 130. The network 140 is typically the Internet, but may be any network, including but not limited to a LAN, a MAN, a WAN, a mobile wired or wireless network, a private network, or a virtual private network.

### Advertising Selection System

The advertising selection system 100 includes various components and modules to enable the advertising selection system 100 to select advertisements for individual client devices 110. Using the persistent identifier maintained by the client device 110 (e.g. a browser cookie), the advertising selection system 100 identifies advertisements to serve to the client device 110. The advertising selection system 100 also identifies user behaviors from referrer information, creates and updates user profiles, and builds behavioral models using the user profiles. These functions are performed by the modules and components within the advertising selection system 100. For clarity in this disclosure, certain particular modules and components are not illustrated or described herein beyond the extent required for illustrating aspects of this disclosure. The system 100 may be implemented using a single computer, or a network of computers, including cloud-based computer implementations. The computers are preferably server class computers including one or more high-performance CPUs and 128 Gb or more of main memory, as well as 500 Gb to 2 Tb of computer readable, persistent storage, and running an operating system such as LINUX or variants thereof. The operations of the advertising selection system 100 as described herein can be controlled through either hardware or through computer programs installed in non-transitory computer storage and executed by the processors of such servers to perform the functions described herein. The advertising selection system 100 includes other hardware elements necessary for the operations described here, including network interfaces and protocols, input devices for data entry, and output devices for display, printing, or other presentations of data. The functions and operations of the advertisement system 100 are sufficiently complex as to require implementation on a computer system, and cannot be performed in the human mind simply by mental steps.

The ad server 101 is a module within the advertising selection system 100 for receiving ad requests from client devices 110 and providing an advertisement or link to the client device 110 to receive an advertisement from an advertiser 130, and is one means for performing this function. The ad server 101 receives the ad request from the client device 110 together with a persistent identifier and referrer link from the client device 110, and is used to select an advertisement from advertiser flights 104 to provide to the client device 110. The persistent identifier and information about the client device 110 may be stored in user profiles 103. In various embodiments, the ad server 101 includes ad service and targeting modules and other logic for selecting particular advertising flights 104 for display to the user.

The advertiser flights 104 is a data store of information describing which advertisers are currently providing advertisements for the advertising selection system 100 to serve to client devices. A flight is a set of ads for a given advertising campaign. The advertiser flights 104 provide information about the advertising campaign by an advertiser. For example, an advertiser flight 104 for a given advertiser typically include a total budget for the advertising flight, the time frame for the advertisements, the average value to the advertiser of a conversion, the average conversion ratio for that advertisers' ad, particular advertising content (e.g., a list of advertisements to be selected from for this advertiser's particular campaign), and other information about the advertising flight. The advertiser flights 104 are provided by advertisers through an interface to the advertiser (not shown) or can be entered by an operator of the advertising selection system 100, for example by a sales manager.

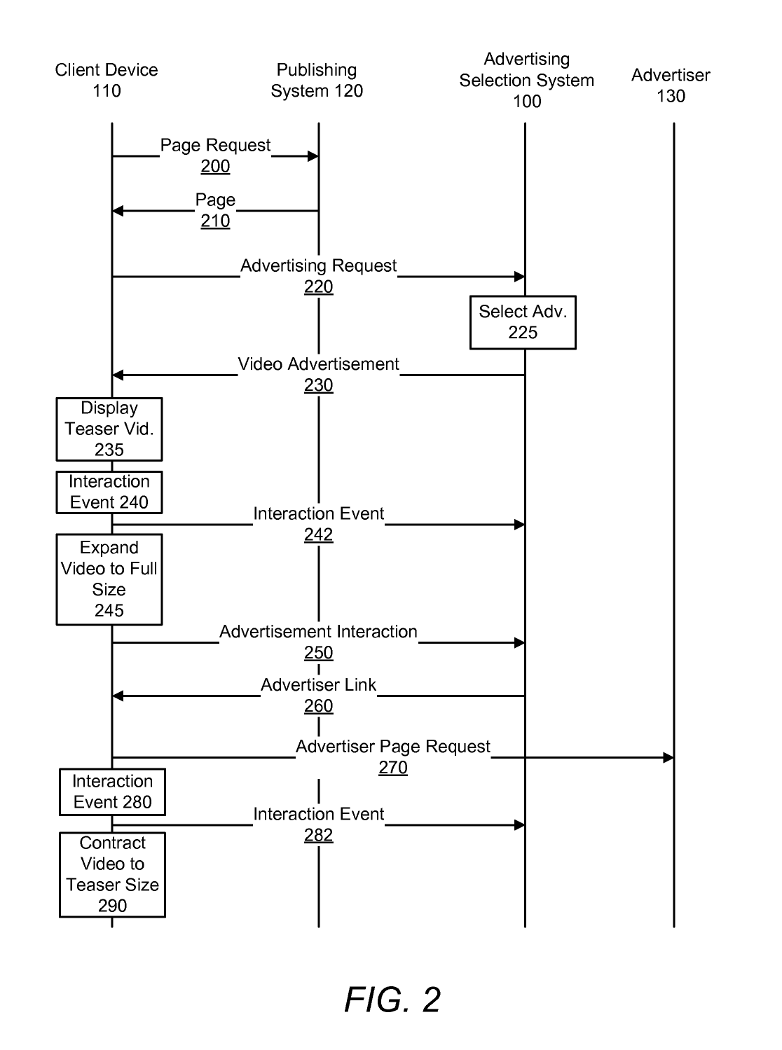

FIG. 2 is an interaction diagram illustrating how an advertisement is provided by the advertising selection system 100 to a client device 110, according to one embodiment. The client device provides a page request 200 to the publishing system 120, such as a request to access a particular URL on the publishing system. The publishing system provides the requested page 210 to the client device as described above. The page 210 includes content and an advertising reference link to the advertising selection system. The client device loads the content and resolves the reference link by requesting an advertisement from the advertising selection system in an advertising request 220. The advertising request 220 includes a persistent identifier, which is used to determine the appropriate type of ad for the user of the client device. The advertising selection system accesses the advertising flights to select 225 a video advertisement for the client device and transmits 230 the video advertisement to the client device.

The client device plays 235 video advertisement is played in a teaser video, which is sized to substantially less than the full video size. In typical embodiments, the teaser video is displayed in sizes ranging from 300×250 to 400×300. In response to the user inputting 240 an initial interaction event with the advertisement, client device expands 245 the teaser video at full size. In typical embodiments, the full size video is displayed in sizes ranging from 600×450 to 950×570. Expanding the size of the teaser video to a full size video includes both increasing the window size of the underlying video player, and automatically scaling the size of the video itself.

The interaction event is also transmitted 242 to the advertising selection system. Additional interaction events 240 may also be provided to the advertising selection system, such the user interacting with portions of the page unrelated to the advertisement or otherwise exiting the video advertisement. The interaction events received by the advertising selection system may be used to determine the amount of a video shown to the user or the extent of user engagement in a video. These metrics in turn are used to determine which advertisements to provide to a client device and an amount to charge advertisers for providing the video.

Users may also interact with the advertisement, for example by clicking on the advertisement, to request access to the advertiser's webpage. The advertisement interaction 250 is reported to the advertising selection system, which provides an advertiser link 260 to the client device. The client device resolves the advertiser link 260 and provides an advertiser page request 270 to the advertiser. Users may also interact with additional elements associated with the video which may provide requests to the advertising selection system or the advertiser.

While the full-size video is displayed or during the expansion of the video, the user may interact with another portion of the webpage outside the expanding video. This interaction is registered as another interaction event 280. The interaction event 280 is also reported 282 to the advertising selection system 100. In addition, the video stops expanding and in one embodiment contracts 290 to the teaser video. The advertising selection system 100 may use the interaction event 280 to determine, for example, the amount of time between the user's first interaction event 240 indicating user interest, and second interaction event 280, indicating user disinterest. Thus, the advertising selection system 100 may determine user interest in the video based on the amount of time the user expanded the video prior to interacting with another portion of the display. The user may re-engage the teaser video by a new interaction event 240.

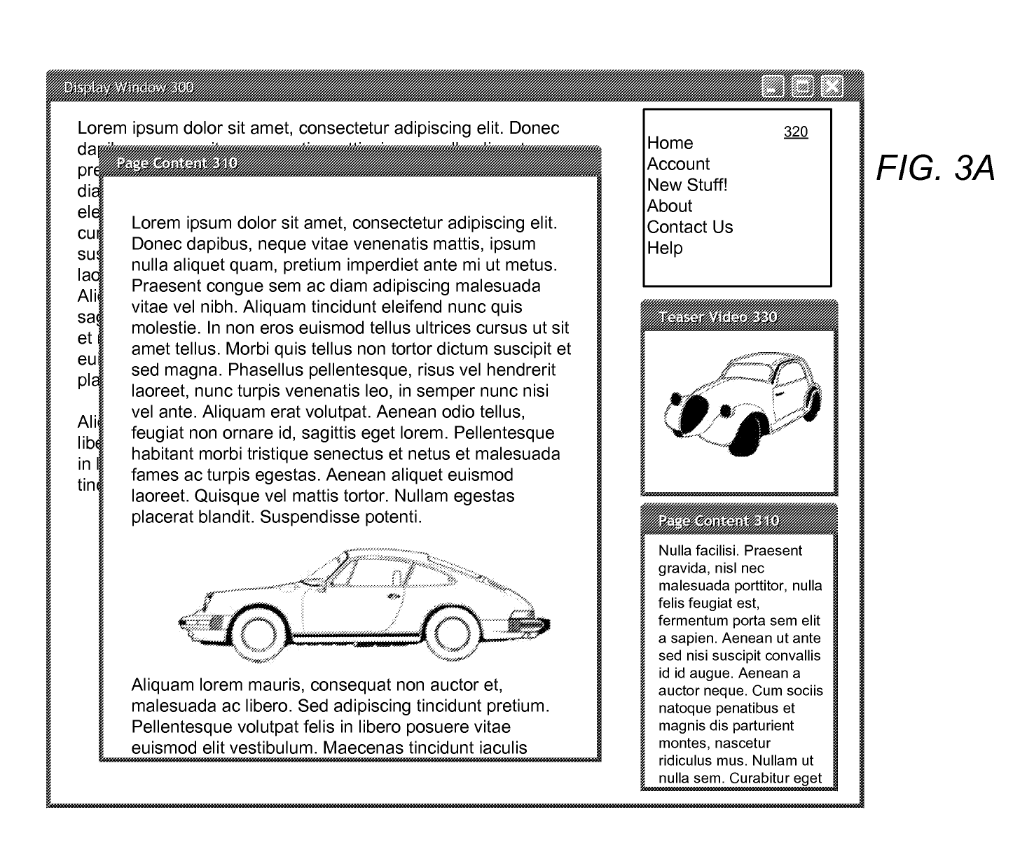

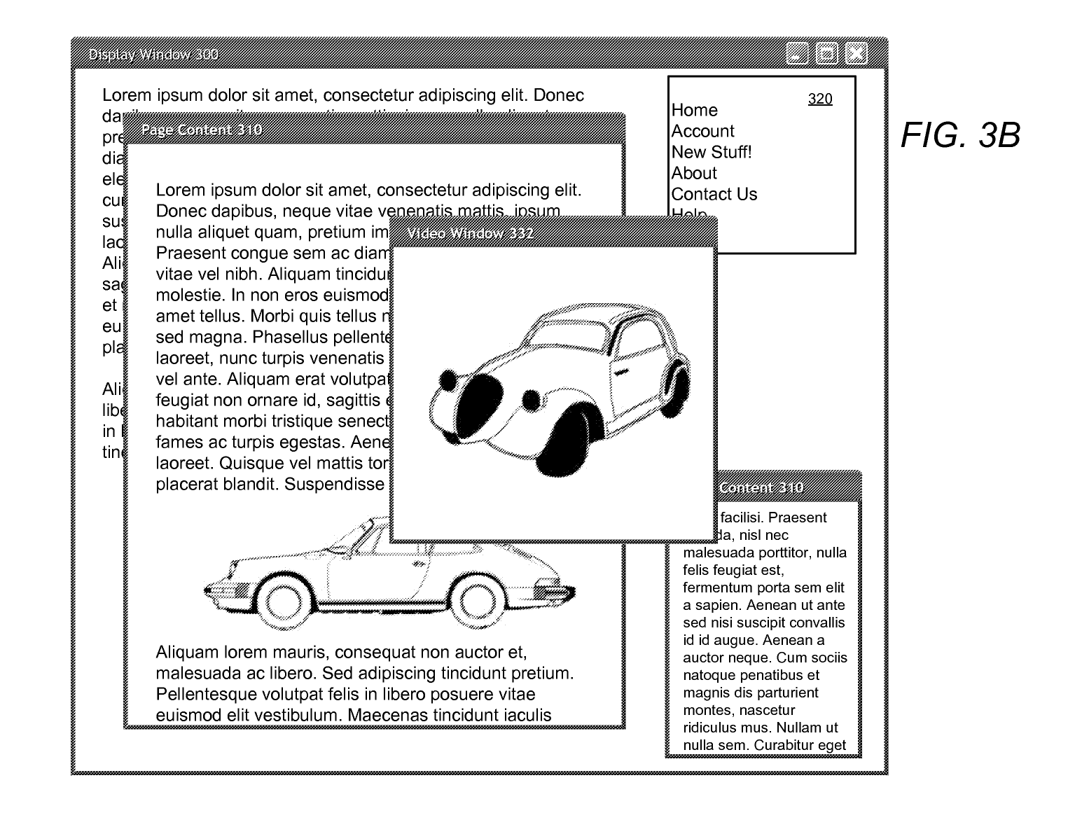

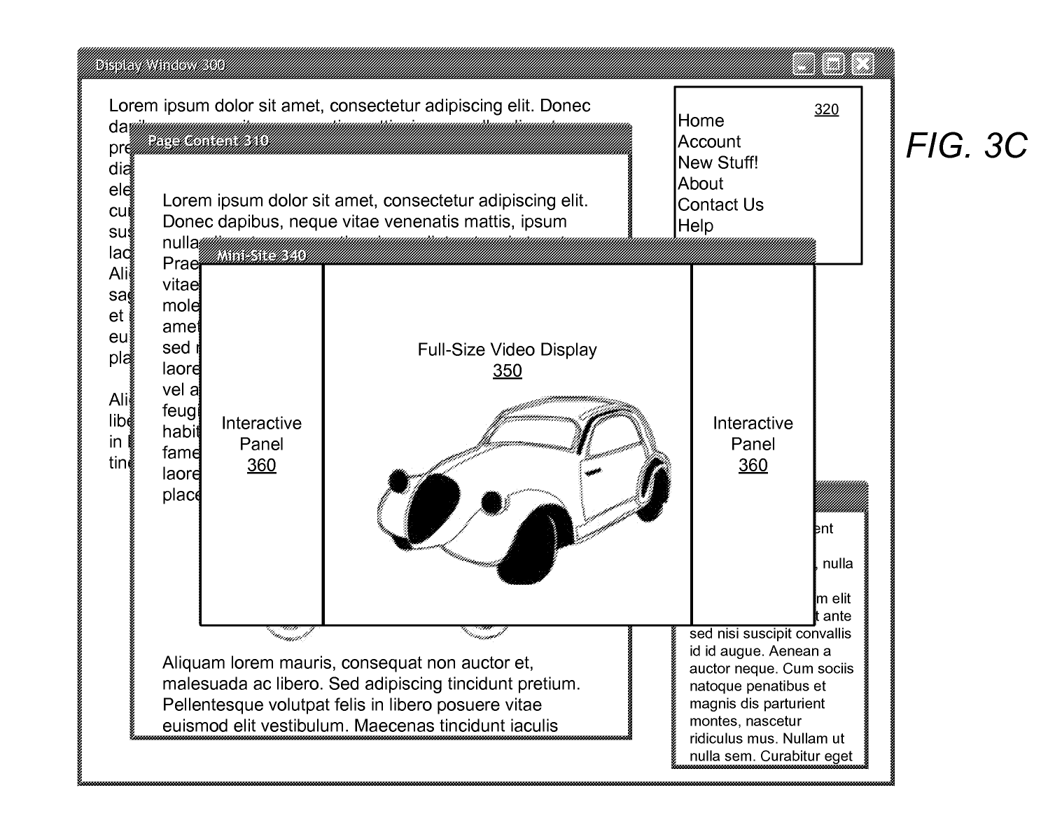

FIGS. 3A-C are illustrations of example user interfaces for a video advertisement according to one embodiment. Initially referring to FIG. 3A, the client device 110 generates a display window 300. The display window 300 in this embodiment includes several portions on which information is displayed to the user. The display window 300 is typically arranged according to information provided by the publishing system 120, for example according to a mark-up language document, script language, or other programmatic means. As shown, the display window 300 includes page content 310, a navigation panel 320, and a teaser video 330. The page content 310 and navigation panel 320 are provided for illustration in this example—in practice the teaser video 330 may be included along with any content presented to the user by the client device 110. The page content 310 in this example is displayed in a main portion of the display window 300 and also in a sidebar portion on the lower right side of the display window 300. The page content 310 is content provided by the publishing system 120 that may comprise any type of information the user accesses at the publishing system 120. The page content 310 may be provided by another system rather than the publishing system 120. The navigation panel 320 allows the user to navigate content on the publishing system 120 and may include links to other pages from the publishing system or other entities on the network.

The teaser video 330 is generated by video player application, and displays a video in a portion of the client device display window 300. Though shown here on the right of the display window 300, the teaser video 330 may be located on any portion of the display window, such as the top or bottom. The teaser video 330 may play the entire length of the video, which may be several minutes or more. Alternatively, the teaser video display 330 may loop over a portion of a video. The video file played in the teaser video 330 is accessed by the player application from the advertising selection system 100 and may be streamed to the client device 110 or may be downloaded. The teaser video 330 can be configured so as initially mute the audio portion of the video during playback. The client device 110 monitors user interaction with the display window 300, page content 310, teaser video 330 and navigation panel 320 via input devices such as a pointing device or a touch screen on the user device 110. When the user interacts with the teaser video 330, for example by placing a cursor over the teaser video 330, the client device registers an advertisement interaction and causes the teaser video 330 to expand.

An illustration of the expanding video is shown in FIG. 3B, and an illustration video once it is fully expanded is shown FIG. 3C. As shown in FIG. 3B, the expanding video window 332 is an intermediary stage between the teaser video 330 and a full-size video 350 shown in FIG. 3C. Not shown are a number of interstitial displays of the window 332 between the teaser video 330 and the full size video window 350, which are sized between the teaser video 330 and the full size video 350. The expanding video window 332 provides a display for substantially smooth and visually continuous transition between the teaser video 330 and the full-size video display 350. The video expands in size over a predetermined amount of time from the teaser video 330 to the full-size video 350, for example over three seconds. During the expansion, the expanding video display 332 continues to play the video from the frame of the teaser video 330 when the user interacted with the teaser video 330. As the window 322 is expanding, the video content is scaled accordingly to fill the window. Window expansion and video scaling are native functions of the video player 114. For example, in the Adobe Flash Player, the scaling of the video is performed using the “tweenlite” class to resize the player. Sample code for performing the video expansion is shown in Appendices A and B.

The client device 110 may also increase the audio volume of the video during the expansion. If the audio was muted in the teaser video, the audio may progressively increase in volume from the muted volume to a full volume as the video expands. Sample code for enabling audio of a video is shown in Appendix C. Alternatively, the audio may remain muted during the expansion.

During the expansion, the user may interact with another portion of the display window 300 outside the expanding video window 332, for example by placing the cursor outside the area of the teaser video 330 and the expanding video window 332. When the user interacts with another portion of the display window 300, the video window 332 stops expanding, and in one embodiment, begins contracting in size and location to the teaser video 330. The user may re-engage the video window 332 by interacting with the teaser video 330 again. The user's interaction with another portion of the display may be recorded and transmitted to the advertising selection system 100 as indications of the user's interest in the video.

When the full-size video window 350 is visible, the remaining portions of the display may be masked or obscured in whole or in part, thus drawing the user's focus to the full-size video display window. The masking may be translucent, such that the user may still view other portions of the display, such as portions of the page content 310.

The full-size video window 350 may be placed in a mini-site 340, which includes both the window 350 along with additional content portions. The mini-site may be loaded from the advertising selection system 110. In one embodiment, the client device renders the display through a browser. In one implementation of this embodiment, when the video expands and displays the mini-site, the browser does not change the page (i.e., the URL) accessed by the user.

When the video is finished playing in the full-size video display 350, a subsequent action may be taken. For example, a second video may begin playing in the full-size video window 350, or the video advertisement may be repeated. The mini-site may also change, for example to provide additional information or invite the user to visit the advertiser's website.

If the user interacts with another portion of the display outside the mini-site 340 or selects a close button, the video returns to the teaser video 330. In one embodiment, the video is immediately returned to the teaser size. In another embodiment, the video is returned to teaser size by contracting the video to the teaser video 330 as shown in FIG. 3A. The video in one embodiment is contracted smoothly in a reverse of the expansion described above. In this embodiment, the video contracts to the video window 332 shown in FIG. 3B prior to returning to the teaser video 330 as shown in FIG. 3A. In another embodiment, rather than smoothly contract to the teaser video 330, the video may immediately return to teaser video 330 to allow the user to interact with the page content 310 immediately. The audio for the video may also be reduced or muted when the video is returned to the teaser video 330.

Thus, the video advertisement is responsive to user interactions showing interest and disinterest in the video, as determined by interaction with the teaser video 330 and interaction with another portion of the display 300. When the user is disinterested, the user remains on the original content page. In addition, the smooth transition of the video from the teaser video to the full-size video maintains user interest in the video.

### User Engagement

A set of user engagement studies were performed to determine user engagement of smoothly expanding videos relative to videos without smooth expansion. These user engagement studies are now described.

A first study compared videos that played a teaser video in a portion of the webpage. Table 1 summarizes the results of the first study. The video played to the user was identical across the test examples. In the “mini-site only” scenario (row 1), when the user interacts with the teaser video, the video immediately loads a mini-site and plays the video within the minisite. In “Expanding A”, the video re-started when the user interacted with the teaser video and smoothly expanded. The expanded video transitioned to a minisite after the number of seconds designated after the transition type. For example, “Expanding A, 12” transitioned to a mini-site after 12 seconds; “Expanding A, 17” transitioned after 17 seconds, and so forth. In “Expanding B,” the video continued from the place in the video from which the user started engagement, here too following a delay as specified. “Engagement” was defined as user interaction with a teaser video for more than three seconds. The “average seconds of video” statistic measured the average number of seconds of the total video that engaged users viewed. For transition videos, the average seconds of video include both expanding teaser video and expanded video a user watched. As shown by Table 1, the expanding video significantly increased user engagement percentages (average “Expanding” engagement 2.57%, about a 200% increase over mini-site engagement of 0.85%) and the amount of video watched by users as measured by the average seconds of video watched (average of 28.33 seconds, about an 89% increase on over mini-site average of 15.0 seconds).

TABLE 1

| | Teaser | | | Avg. Sec. |
|---|---|---|---|---|
| | Impressions | Engagement | Engagement % | Video |
| Mini-site Only | 18334 | 156 | 0.85% | 15.0 |
| Expanding A, 12 | 18170 | 502 | 2.76% | 27.6 |
| Expanding A, 17 | 18170 | 449 | 2.47% | 32.3 |
| Expanding A, 22 | 18170 | 449 | 2.47% | 24.2 |
| Expanding A, 27 | 18170 | 480 | 2.64% | 28.5 |
| Expanding B, 12 | 18170 | 410 | 2.26% | 30.9 |
| Expanding B, 17 | 18170 | 422 | 2.32% | 26.1 |
| Expanding B, 22 | 18170 | 518 | 2.85% | 28.4 |
| Expanding B, 27 | 18170 | 509 | 2.80% | 28.6 |

Table 2 summarizes the results of a second user engagement study. In the second study, “Expanding Only” indicates a video that does not transition to a mini-site. Thus, the expanding-only video expands when the user interacts with the teaser video, but does not transition to a mini-site. Like the first user engagement study, Table 2 shows that both increased user engagement (average of “Expanding” type, 2.65%, about a 165% increase over min-site engagement of 1.00%) and length of video views (average of 27.79 seconds, about an 92% increase on over mini-site average of 14.5 seconds).

TABLE 2

| | Teaser | | Engagement | Avg. Sec. |
|---|---|---|---|---|
| | Impressions | Engagement | % | Video |
| Mini-site Only | 39,989 | 380 | 1.0% | 14.5 |
| Expanding Only A | 36,000 | 962 | 2.7% | 21.7 |
| Expanding A, 12 | 36,000 | 911 | 2.5% | 29.4 |
| Expanding A, 17 | 36,000 | 956 | 2.7% | 29.4 |
| Expanding A, 22 | 36,000 | 1,023 | 2.8% | 29.8 |
| Expanding A, 27 | 36,000 | 968 | 2.7% | 30.5 |
| Expanding Only B | 36,000 | 917 | 2.5% | 21.0 |
| Expanding B, 12 | 36,000 | 925 | 2.6% | 26.9 |
| Expanding B, 17 | 36,011 | 969 | 2.7% | 28.7 |
| Expanding B, 22 | 36,000 | 953 | 2.6% | 29.0 |
| Expanding B, 27 | 36,000 | 958 | 2.7% | 31.5 |

Table 3 illustrates the results of a third user engagement study. In this study, user “clicks” were also measured and a percentage of clicks per engaged user (C/E) was also determined. A “click” is an interaction of the user to further interact with the advertiser by proceeding to a link provided with the video to the advertiser's website or URL. Again, the Expanding types demonstrated significant increases in engagement percentages, percentage clicks per engaged user, and average time of video viewed.

TABLE 3

| | Teaser | | Engagement | Avg. | Clicks % | Avg. Sec. |
|---|---|---|---|---|---|---|
| | Impressions | Engagement | % | Clicks | (C/E) | Video |
| Mini-site Only | 80,000 | 481 | 0.60% | 4 | 0.83% | 11.1 |
| Expanding Only A | 80,000 | 731 | 0.91% | 11 | 1.50% | 17.9 |
| Expanding A, 7 | 80,000 | 750 | 0.94% | 12 | 1.60% | 25.6 |
| Expanding A, 12 | 80,000 | 717 | 0.90% | 18 | 2.51% | 27.0 |
| Expanding A, 17 | 80,000 | 750 | 0.94% | 13 | 1.73% | 24.7 |

As shown by the preceding user engagement studies, the smoothly expanding video provides significant improvements relative to an immediate presentation of a large video in a mini-site. These improvements are shown in user engagement frequency, length of viewing, and click-through rates.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

APPENDIX A
Sample Javacode for performing window expansion:
TF_toolbarIBV.prototype.calculateExpandData = function (isInitToolbar) {

var that = this;
var factor = 100;
if (that.browserProperties.browser.zoomFactor) {

factor = that.browserProperties.browser.zoomFactor;

}
factor = 100 / factor;
if (isInitToolbar) {

var widthDiff = that.inBanner.widthInit − that.inBanner.width;
var heightDiff = that.inBanner.heightInit − that.inBanner.height;

} else {

widthDiff = that.inBanner.widthExpanded − that.inBanner.width;
heightDiff = that.inBanner.heightExpanded − that.inBanner.height;

}
var collapsedClip = that.inBanner.collapsedClip;
var expandedClip = new Object( );
expandedClip.left = collapsedClip.left − widthDiff;
expandedClip. top = collapsedClip.top − heightDiff;
expandedClip.right = collapsedClip.right;
expandedClip.bottom = collapsedClip.bottom;
that.inBanner.expandedClip = expandedClip;
var dynamicDiv =

that.windowObj.document.getElementById(that.inBanner.dynamicDivId);

if (!isInitToolbar) {

dynamicDiv.style.clip = “rect(” + expandedClip.top * factor + “px ” +

expandedClip.right * factor + “px ” + expandedClip.bottom * factor + “px ” + expandedClip.left
* factor + “px)”;

that.inBanner.clip.current = expandedClip;

}
var flashObj = that.getFlashObject(that.inBanner.flashId, that.windowObj);
try {

if (flashObj) {

flashObj.sendDirectionData(expandedClip.left, expandedClip.top,

expandedClip.right, expandedClip.bottom);

}

} catch (e) {
}

};

APPENDIX B
Sample Flash code for resizing a video:

function startExpansion( )
{
sendFlashEvents(“transitionMidStart”);
unloadSN( );
borderMC._visible = false;
btnExplore._visible = false;

aniMC._visible = true;
aniMC.gotoAndPlay(“up”);
borderMC._visible = false;
vPlayer.disableBtn._visible = true;
if (isFEVDivCalled == false)

{
soundTimer = setTimeout(autoSoundOn, autoSoundTime);

}
TweenLite.killTweensOf(vPlayer);

TweenLite.to(vPlayer,_root.tweenExapndDuration,
{width:playerObj.Width,
height:playerObj.Height, _x:playerObj. xPos,_y:playerObj.yPos,
ease:Regular.easeIn, onComplete:expandComplete});

| resetElements(_root.tweenExapndDuration,“expand”); | |
|---|---|
| if (isInteracted) | { |

| | logoMC._visible = true; | |
|---|---|---|
| } | else | { |

if(showPanelOnload ==

“true” ∥ showPanelOnload == true ){
logoMC._visible = true;

}else{

logoMC._visible = false;

}

}

}

```
APPENDIX C
  Sample Flash code for playing audio:
  _global.unmuteVideo = function(bool)
  {
```

prevDisVolume = 50;
_root.sendFlashEvents(“videoUnmute”);
m._width = Math.round(Math.min(100, isNaN(prevDisVolume) ? 0 :

prevDisVolume) / 100 * 39 / 4) * 4;

```
_parent.vol.tf.text = Math.round(isNaN(prevDisVolume) ? 0 :
prevDisVolume);
_root.so.setVolume(prevDisVolume);
_btnMute._visible = false;
_btnUnmute._visible = true;
if(bool)
{
  if (_root.bannerState != “floating”)
  {
```

_root.trackExpEvent(“Unmute”);

```
  }
  else
  {
```

_root.trackEvent(“Unmute”);

}
}
my_var = false;

};

What is claimed is:

1. A computer-implemented method for engaging a user of a client device with a video advertisement, the method comprising:
receiving, by the client device, an advertisement from an advertising system, the advertisement including a video;
displaying the video in a teaser video window on the client device;
receiving a user interaction with the teaser video window of the display;
responsive to the user interaction with the teaser video window, expanding the teaser video window to a full-size-video window on the display, wherein the teaser video window is initially smaller than the full size video window, and the expansion of the video performed substantially smoothly from the teaser video window to the full-size-video window over an expansion period comprising a predetermined amount of time.

2. The computer-implemented method of claim 1, further comprising providing a user engagement indication to the advertising system after the expansion period.

3. The computer-implemented method of claim 1, wherein the teaser video window is contained in a webpage.

4. The computer-implemented method of claim 1, wherein the user interaction is a mouse-over of the teaser video window.

5. The computer-implemented method of claim 1, further comprising:
receiving, during the expansion period, a user interaction with a second window that does not include the teaser video window; and
halting the expansion of the teaser video window after receipt of the user interaction the second window.

6. The computer-implemented method of claim 1, further comprising restarting the video in response to the teaser video window being expanded to the full-size-video window.

7. The computer-implemented method of claim 1, further comprising muting an audio portion of the video while the video is displayed in the teaser video window, and outputting the audio portion of the video while the video is displayed in the full-size-video window.

8. The computer-implemented method of claim 7, further comprising progressively increasing a volume of the audio portion during the expansion period.

9. The computer-implemented method of claim 1, wherein the full-size-video window is included in a mini-site.

10. The computer-implemented method of claim 1, further comprising playing a second video in the full-size-video window after the video ends.

11. A computer-implemented method for engaging a user of a client device with a video advertisement, the method comprising:
receiving, by an advertising system, a request for an advertisement from the client device;
selecting, by the advertising system, a video advertisement;
providing, by the advertising system to the client device, a video advertisement and instructions for providing the video advertisement to the user of the device, the instructions directing the client device to:
play the video advertisement in a teaser window;
receive a user interaction with the video advertisement in the teaser window; and
responsive to receiving the user interaction with video advertisement, expand the teaser window to a full-size-video window, the expansion of the teaser video window to the full size video window performed substantially smoothly over an expansion period comprising a predetermined amount of time.

12. The computer-implemented method of claim 11, wherein the instructions further comprise directing the client device to provide a user engagement indication to the advertising system after the expansion period.

13. The computer-implemented method of claim 11, wherein the teaser video window is contained in a webpage.

14. The computer-implemented method of claim 11, wherein the user interaction is a mouse-over of the teaser video window.

15. The computer-implemented method of claim 11, wherein the instructions further comprise directing the client device to:
receive during the expansion period, a user interaction with a second window that does not include the teaser video window; and
halt the expansion of the teaser video window after receipt of the user interaction the second window.

16. The computer-implemented method of claim 11, wherein the instructions further comprise directing the client device to restart the video in response to the teaser video window being expanded to the full-size-video window.

17. The computer-implemented method of claim 11, wherein the instructions further comprise directing the client device to mute an audio portion of the video while the video is displayed in the teaser video window, and outputting the audio portion of the video while the video is displayed in the full-size-video window.

18. The computer-implemented method of claim 17, wherein the instructions further comprise directing the client device to progressively increase a volume of the audio portion during the expansion period.

19. The computer-implemented method of claim 11, wherein the instructions further comprise directing the client device to play the full-size-video video window in a mini-site.

20. The computer-implemented method of claim 11, wherein the instructions further comprise directing the client device to play a second video in the full-size-video window after the video ends.
